(19) United States
(12) Patent Application Publication
(10) Pub. No.: US 2007/0106487 A1
(43) Pub. Date: May 10, 2007

(54) Methods for optimizing efficiency and durability of rotary drag bits and rotary drag bits designed for optimal efficiency and durability

(76) Inventors: David Gavia, The Woodlands, TX (US); Jack T. Oldham, Conroe, TX (US); Mathews George, Houston, TX (US); Michael L. Doster, Spring, TX (US)

Correspondence Address: TRASK BRITT, P.O. BOX 2550, SALT LAKE CITY, UT, 84110, US

(21) Appl. No.: 11/594,710

(22) Filed: Nov. 8, 2006

Related U.S. Application Data
(60) Provisional application No. 60/734,571, filed on Nov. 8, 2005.

(51) Int. Cl. G06G 7/48

(52) U.S. Cl. 703/7

(57) ABSTRACT

A method for evaluating existing drill bits and drill bit designs includes measuring several desired characteristics of a bit, including the wear experienced in drilling a formation, such as an actual formation or a simulated formation or a laboratory test fixture. A computer model may be used to evaluate the work-force and/or the sliding-wear rates that cutting elements of the bit experience as compared with the rate-of-penetration and/or durability of the bit. This information may be used to design a new drill bit, which may involve modification of the cutting elements (e.g., moving the location, volume (size and shape) or number of cutting elements from areas of the bit that receive lower work-force and sliding-wear rates to those areas that experience relatively greater work-force and sliding wear-rates. This may permit the cutting elements to be oriented more aggressively relative to a formation to be drilled. Other parameters that may be optimized include the bit profile, blade count, hydraulics, or the like.

### CROSS-REFERENCE TO RELATED APPLICATION

This application claims the benefit of U.S. Provisional Application No. 60/734,571, filed Nov. 8, 2005, the disclosure of which is hereby incorporated herein, in its entirety, by this reference.

### BACKGROUND OF THE INVENTION

1. Field of the Invention

The present invention relates to rotary drag bits for drilling subterranean formations and their operation. More specifically, the present invention relates to a method of designing such bits for optimum performance by evaluating the work-force rate and sliding-wear rate of the cutting elements on a bit and positioning the cutting elements so as to improve the overall durability and efficiency of the bits.

2. State of the Art

The drilling industry has employed rotary drag bits for nearly a century, and has undergone significant change since then. Today, the most common rotary drag bits are impregnated diamond bits and bits with polycrystalline diamond compact (PDC) cutting elements, or “cutters.” Impregnated diamond bits, rather than having separate cutters, consist of many, relatively small, diamonds, or diamond particles, set in a tungsten carbide matrix throughout the face and crown of the bit. Impregnated diamond bits perform best in non-brittle, plastic formations, abrasive formations, and high-rotary speed drilling. PDC cutting elements typically comprise a disc-shaped diamond “table” formed on a supporting substrate (e.g., a cemented tungsten carbide (WC) substrate, etc.) and bonded to the substrate under high pressure, high temperature conditions. Many separate PDC cutting elements are inserted into and secured within (e.g., brazed into, etc.) pockets in the bit face and in blades that extend from the face, or are mounted to studs inserted into the bit body. Bits carrying PDC cutting elements have proven very effective in achieving high rates of penetration (ROP) in drilling subterranean formations exhibiting low to medium compressive strengths.

The rotary drag bit is placed at the end of a long string of hollow steel tubulars, or drill pipe, to drill a well. A single pipe, or joint, of drilling tubular is approximately 30 feet (about 10 m), and three drill pipes frequently are threaded together to form a single, ninety foot (about 30 m) stand. Individual stands of pipe are then threaded together to form an entire drill string that reaches the bottom of the well, with subsequent stands added as needed as the well is drilled deeper. A drill string may reach a length of hundreds or thousands of feet, and may even be several miles or kilometers long. The drill string with the bit attached is then turned from the surface with a rotary drive mechanism; in some instances, a down-hole motor is located between the drill pipe and the bit additionally turns the bit. For drilling a well with a specified geometry, a down-hole motor or turbine in combination with a bent housing or sub may be used to rotate the bit alone while the pipe remains stationary.

The economic cost of drilling a well strongly depends upon the ROP, or the rate at which the bit drills into the formation, usually measured in feet per hour (or meters per hour). Therefore, subject to several constraints, such as limits to a particular drilling rig, formation characteristics, drilling fluid properties, and others, a drilling contractor seeks to maximize the ROP, which minimizes the cost per foot (or meter) drilled.

In addition to the rate at which a particular bit drills, another significant factor in the economic efficiency of drilling a well is the durability of the bit, or that rate at which its cutting elements wear. That is, it is desirable to have a bit drill as long as possible before it must be replaced due to dulling of or damage to the cutting elements. As mentioned, the bit is located at the end of a string of drill pipe. To replace a worn bit, the entire string must be pulled or “tripped” out of the hole either by the single joint or by the stand, a time consuming process in any case, more so when the string extends several miles into the earth and takes upwards of a day to remove from the well. Thus, it is desirable to have a bit that wears less for a given amount of formation drilled.

An unmet need exists for a method of designing drill bits that associates the work-force rate and sliding-wear rate to the volume and location of cutting elements. Other factors may further by optimized in conjunction with the present invention. Other factors of bit design, including, without limitation, back-rake and side-rake angles, cutter edge geometry (e.g., chamfer, etc.), bit profile, or others, may be further individually optimized or in combination. Examining these aforementioned factors holistically, rather than individually, provides a novel solution that increases the life of a bit (distance drilled), aggressiveness (ROP), and efficiency (the rate or manner in which the bit wears).

### BRIEF SUMMARY OF THE INVENTION

The present invention includes methods for designing drill bits that include evaluating a combination of factors to optimize the duration and efficiency of the bit.

The method includes several acts, the order of which may be taken in a manner that best suits the needs of the person practicing the invention. A drill bit drills a formation, which may occur in a computer simulation, a laboratory test, or in the field on a drilling rig. The cutting elements are evaluated, which may include the work-force rate and the sliding-wear rate. “Work-force rate” is a calculation of the force on the cutting elements and the distance over which that force is applied, and may be normalized against a benchmark, which may include distance drilled or ROP, among others. “Sliding-wear rate” evaluates the dull condition of a cutting element, which may include the area of the cutting element worn away for a given distance that the cutting element travels across a formation during drilling thereof.

A bit design may incorporate information gathered during drilling. The bit design may include an adjustment of the number of cutting elements on a bit, an adjustment of the location of one or more cutting elements on the bit, an adjustment to the orientation of one or more cutting elements of the bit, a change in the number of blades on the bit, a change in the profile, or length of the bit, alteration of bit hydraulics, or a combination of any of the foregoing. Such changes may improve the durability or efficiency of the bit. For example, cutting elements may be added to, deleted from, or moved from locations in a prior bit design. Such changes reduce the number of cutting elements that experience a low work-force or sliding-wear rate, while increasing the number of cutting elements at locations in a new bit design where the cutting elements experience greater work or wear. Again, the total number of cutting elements may stay the same as compared to the original bit, or may increase or decrease. Finally, the process may include selecting a particular rotary drag bit to drill a given formation, as well as optimizing a rotary drag bit to drill a given formation.

Optionally, the new bit design may be tested by drilling a formation, similar to the test conducted on the previous bit design, or by another method. The new bit design may be evaluated for work-force rate, sliding-wear rate, and/or other characteristics of interest. The new bit design may be further modified to alter or enhance desired traits, which may include the aggressiveness, the durability/redundancy of cutting elements, efficiency, or other traits, individually or in combination.

A drill bit that has been designed in accordance with the teachings of the present invention is also within the scope of the present invention. Such a drill bit may include features, such as cutting elements, that are arranged and oriented to optimize the achievable ROP while minimizing the wear of the cutting elements by placing an adequate number of cutting elements in those locations that previously exhibited adverse work-force and sliding-wear rates.

Other features and advantages of the present invention will become apparent to those of skill in the art through consideration of the ensuing description, the accompanying drawings, and the appended claims.

### BRIEF DESCRIPTION OF THE SEVERAL VIEWS OF THE DRAWINGS

FIG. 1 is a flow chart depicting an example of an embodiment of a bit design method of the invention;

FIG. 2 is a flow chart depicting another embodiment of a bit design method of the invention;

FIG. 3 is a graph that includes a plot of ROP vs. distance drilled for existing and newly designed bits;

FIG. 4 depicts an axial view and a cutting element profile of an existing bit design;

FIG. 5 illustrates a cutting element profile of another existing bit design;

FIG. 6 shows an axial view and a cutting element profile of a bit that has been designed in accordance with teachings of the present invention;

FIG. 7 is a graph comparing the fraction of cutting elements removed to the radial positions of the cutting element on their corresponding bits, for both existing bit designs and bits that have been designed in accordance with teachings of the present invention;

FIG. 8 includes an axial representation and a cutting element profile of another existing bit;

FIG. 9 provides an axial view and a cutting element profile of another bit that has been designed in accordance with teachings of the present invention;

FIG. 10 is a graph of the work rate of each cutting element on three unworn, existing bits and one unworn bit designed by a method of the present invention plotted against the radial positions of the cutting elements from the axes of rotation of their respective bits;

FIG. 11 is a graph of the work rate of each cutting element of the bits represented in FIG. 10 plotted against the radial position of each cutting element;

FIG. 12 is a graph plotting the fraction each cutting element of the bits represented in FIGS. 10 and 11 removed against the radial position of that cutting element on its corresponding bit; and

FIG. 13 illustrates the wear flat of cutting elements from a bit of existing design and from a bit that has been designed by a method that incorporates teachings of the present invention.

### DETAILED DESCRIPTION OF THE INVENTION

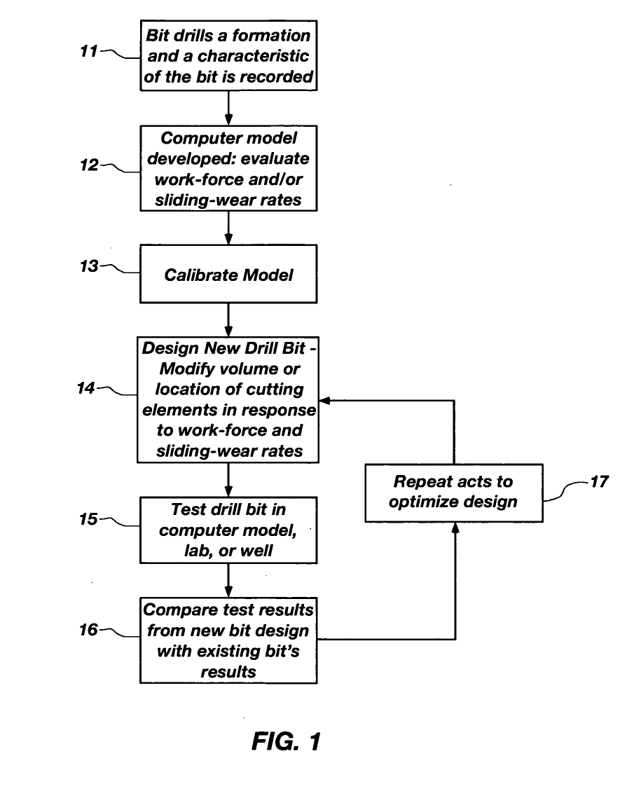

One embodiment of a method according to the present invention includes a series of acts that, while described in a particular order here and in FIG. 1, may be taken in a manner most useful to a person practicing the invention. At reference 11, one or more characteristics of a drill bit that has drilled a formation may be evaluated and recorded. The formation drilled may include an actual well, a laboratory test fixture at either surface or simulated downhole conditions, a computer simulation, or “drilling” may be conducted in any other suitable fashion.

The characteristics that are evaluated during or following drilling may include, but are not limited to, the size, shape, and orientation of a wear flat on one or more cutting elements; the condition of the cutting elements, the bit body, or other features of the bit; characteristics of the formation drilled, including, without limitation, abrasiveness and compressive strength; the drilling fluid used; operating parameters, such as weight-on-bit (WOB) or torque; or any combination of the foregoing.

An algorithmic (e.g., computer-based) model or physical model of the drill bit may be developed, at reference 12, in a manner known in the art. As a nonlimiting example of an algorithmic model, some form of the PDCWEAR computer code or other suitable algorithm or set of algorithms, embodied in a computer program or otherwise, may be used. D. A. Glowka, Use of Single-Cutter Data in the Analysis of PDC Bit Designs: Part 2Development and Use of the PDCWEAR Computer Code, J. Petroleum Tech., 850, SPE Paper No. 19309 (August 1989), the disclosure of which is hereby incorporated herein, in it entirety, by this reference, is an example of a PDCWEAR program that may be used.

The model may include a work-force model, a sliding-wear model, or any other model or combination of models useful for determining the wear or work of one or more individual cutting elements during drilling. The model may account for the location of one or more individual cutting elements, hydraulics, or other parameters of interest. The model may be calibrated, at reference 13, so that it correlates to those characteristics recorded during and after the bit drilled the formation. The model of the bit that drilled the formation may be used as a template for a new bit, or an entirely new drill bit design may be created, as indicated at reference 14 of FIG. 1.

Various factors that affect bit performance may be modified, including, but not limited to, the location or volume of one or more cutting elements, as compared to the location or volume of one or more corresponding cutting elements of a previous bit design. For example, the location of one or more cutting elements may be moved from a location on a bit where they experience a relatively low work-force or sliding-wear rate, or both, to a location on the bit that experiences a relatively high work-force or sliding-wear rate, or both. Other elements that may be adjusted, individually or in combination, include, but are not limited to, the number of blades, or “blade count;” the length or shape of the bit profile; the hydraulics of the bit, including, without limitation, the size, location, or orientation of nozzles and the size, number, or paths of fluid courses; the size, shape, or number of cutting elements; and operating parameters, such as weight on bit, rate of rotation, and the like.

A virtual model of the bit may be run in the previously developed computer model to simulate drilling a formation or a physical model of the bit may be run in a well or a laboratory test fixture, as indicated at reference 15. The results achieved with the new drill bit may be compared with the original bit, at reference 16, with subsequent improvements iteratively tested, at reference 17, if necessary, until an optimum design is reached, which may include optimizing a bit to drill in a specific field, formation, application, or other need. Thus, the process may be used to select an optimum bit design for drilling a formation, which might include using either an existing bit design or developing a new bit design optimized for the particular formation or field.

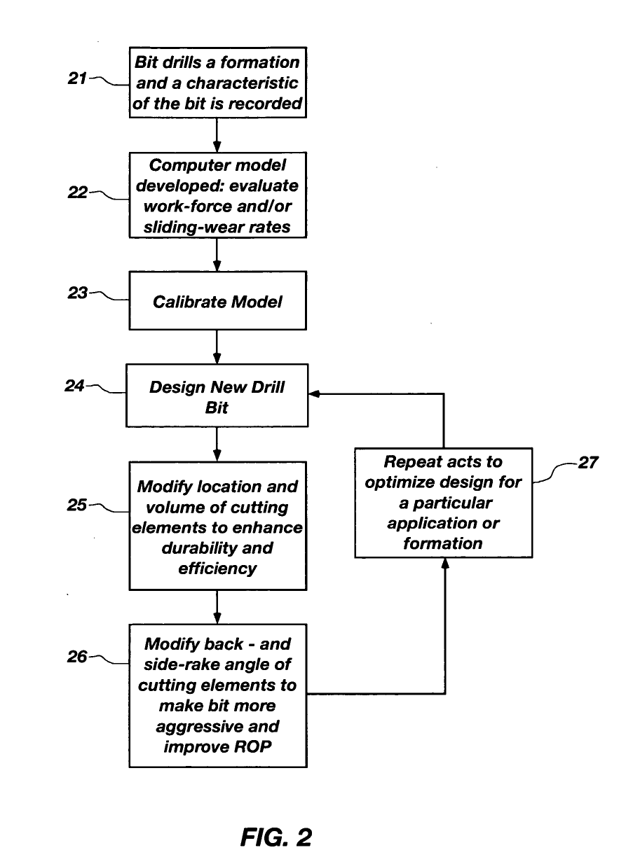

In another embodiment, the manner in which an existing drill bit wears while drilling a formation is recorded, at reference 21 of FIG. 2. The formation drilled may be from an actual well drilled, or it may be from either a computer simulation or a formation drilled in a laboratory test fixture. A computer model of the existing drill bit and the manner in which it or its cutting elements have worn may be created, at reference 22. The model may be calibrated to the observed wear, at reference 23. A new drill bit may be designed using the information from drilling with the previous drill bit, at reference 24. Changes form the existing drill bit to the new drill bit may include increasing the percentage of the volume of cutting elements located in those areas of the existing drill bit that wore more adversely relative to other areas of the drill bit and/or increasing the number of cutting elements located in the adversely worn areas, at reference 25.

The back-rake and side-rake angles of individual cutting elements, or the geometries (e.g., chamfer, etc.) of their edges, may be altered, at reference 26, which may change the aggressiveness with which such cutting elements attack a formation, as well as the overall aggressiveness of the bit. By increasing the volume or number of cutting elements at one or more locations (e.g., radial positions) on a bit where cutting elements exhibit excessive adverse work or wear, the rake angle of one or more cutting elements may be altered to change the aggressiveness with which that cutting element attacks a formation. Side-rake angles affect how a cutting element pushes drilled cuttings to the side of the cutting element, much like the action of a plow. Back-rake angle is the angle of the face of the cutting element relative to a vertical line perpendicular to the face of a formation being drilled, and is usually expressed in terms of a negative angle, although positive back-rake, or forward-raked, cutting element orientations have been proposed. Thus, the cutting face of the cutting element is angled backwards, or leaning away, from the direction of the rotation of the bit. A back-rake angle of 0° would indicate that the cutting element is vertical, or perpendicular to the formation, and may be termed a “neutral” back-rake. The smaller the back-rake angle, i.e. the closer to zero or vertical, the more aggressively the cutting element attacks the formation. Edge geometries may also be tailored to provide desired effects.

The back-rake and side-rake angles, and/or the edge geometry of one or more cutting elements, may be matched to the formation drilled, with more aggressive angles (closer to zero) suitable to softer formations and less aggressive angles suitable for harder formations. Conventionally, more aggressive back-rake and side-rake angles correspond to greater cutting element and bit wear rates. Thus, the durability of a bit and the ROP for which the bit is designed may be optimized as needed or desired for a particular application, at reference 27.

As an example, the aggressiveness of a bit may be maximized at the expense of the wear condition, which may be of particular use for a short drilling section in environments in which costs are particularly high, such as offshore. In other situations, durability might be paramount as compared to aggressiveness, such as in situations where a bit run is anticipated to be quite long and the time needed to trip in and out of the hole is significant. An optimum balance between durability and aggressiveness may be achieved.

Other elements that may be adjusted include, but are not limited to, the profile of the bit; the size, shape and number of the cutting elements; hydraulics of the bit, including placement, orientation, and size of nozzles and fluid courses; stability; and other factors.

The term “stability” refers to the tendency of a bit, in particular PDC bits, to suffer from vibration and whirl, both negatively affecting the durability of a bit. Several attempts to describe and model stability are known in the art, including, for example, C. J. Langeveld, PDC Bit Dynamics, SPE/IADC Paper No. 23867 (1992) (presented at the IADC/SPE Drilling Conference in New Orleans, La., Feb. 18-21, 1992) and Thomas M. Warren, et al., Development of a Whirl-Resistant Bit, SPE Drilling Engineering, 297 (December 1990), the entire disclosure of which is hereby incorporated herein, in its entirety, by this reference.

Another possible factor to be evaluated or modified is bit hydraulics, also known in the art, of which just one example is M. R. Taylor, High Penetration Rates and Extended Bit Life Through Revolutionary Hydraulic and Mechanical Design in PDC Bit Development, SPE Paper No. 36435 (1996) (presented at the 1996 SPE Annual Technical Conference and Exhibition in Denver, Colo., Oct. 6-9, 1996), the disclosure of which is hereby incorporated herein, in its entirety, by this reference.

### EXAMPLE 1

Several bits were evaluated in accordance with teachings of the present invention.

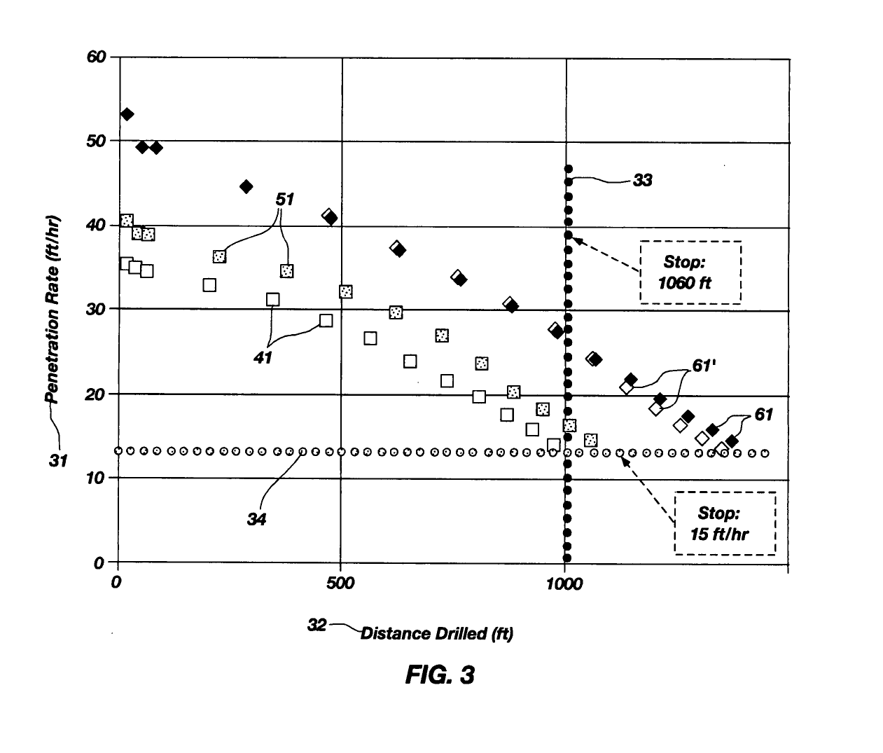

FIG. 3 is a collective plot of data gathered both in the field with existing bit designs from computer simulations of new bit designs. The existing drill bit drilled a given formation and data was gathered, including the ROP and distance drilled. The Y-axis 31 represents the average ROP in feet per hour, while the X-axis 32 represents the distance of formation drilled in feet. The X-axis 32 begins at 0 feet drilled, which indicates that the bit has not drilled a formation, i.e., the bit is new. The distance a bit has drilled increases linearly to the right along the X-axis 32. Imposed on the graph are two criteria upon which the performance of a bit is compared. A dotted vertical line 33 represents a total distance drilled of 1,060 ft (323 m), which has been the distance drilled by a representative group of bits that previously drilled the formation. For purposes of these tests, without limiting the scope of the present invention, dotted horizontal line 34 indicates a ROP of 15 ft/hr (about 5 m/hr), a criterion that may be used to determine when to stop drilling and to pull out of the hole to replace a worn bit. When a given bit's average ROP falls to 15 ft/hr (about 5 m/hr) or any other predetermined minimum ROP, it may be presumed that the cutting elements of the bit have been worn beyond their useful lives, and the drill string may be pulled out of the hole so that the bit may be replaced.

The existing bit designs are represented by reference numerals 41 and 51, while the bits that have been designed in accordance with teachings of the present invention are represented by reference characters 61 and 61′.

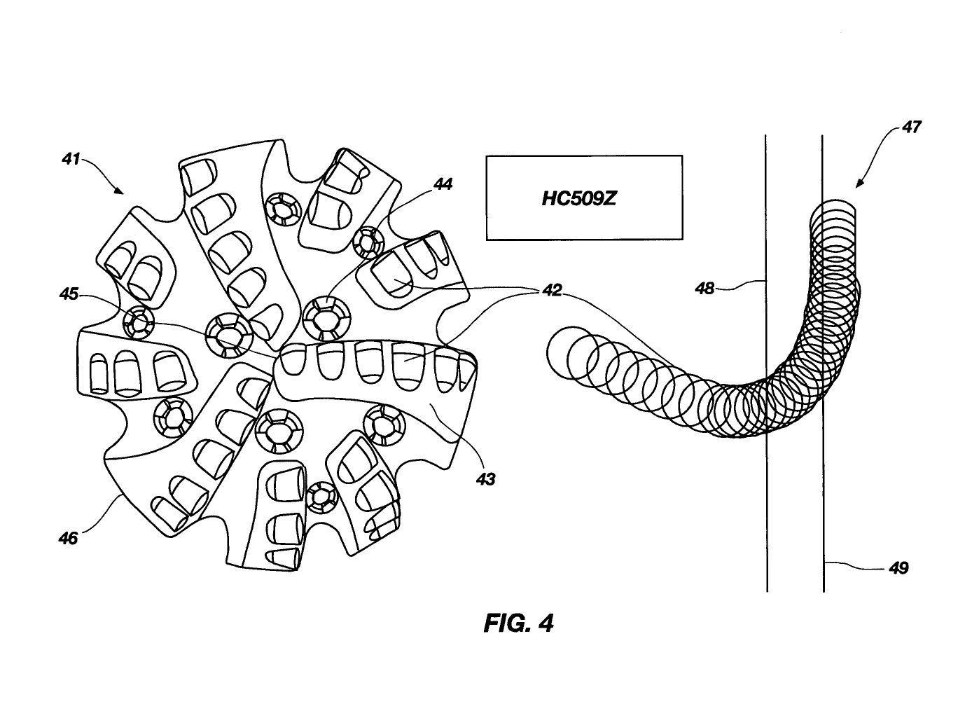

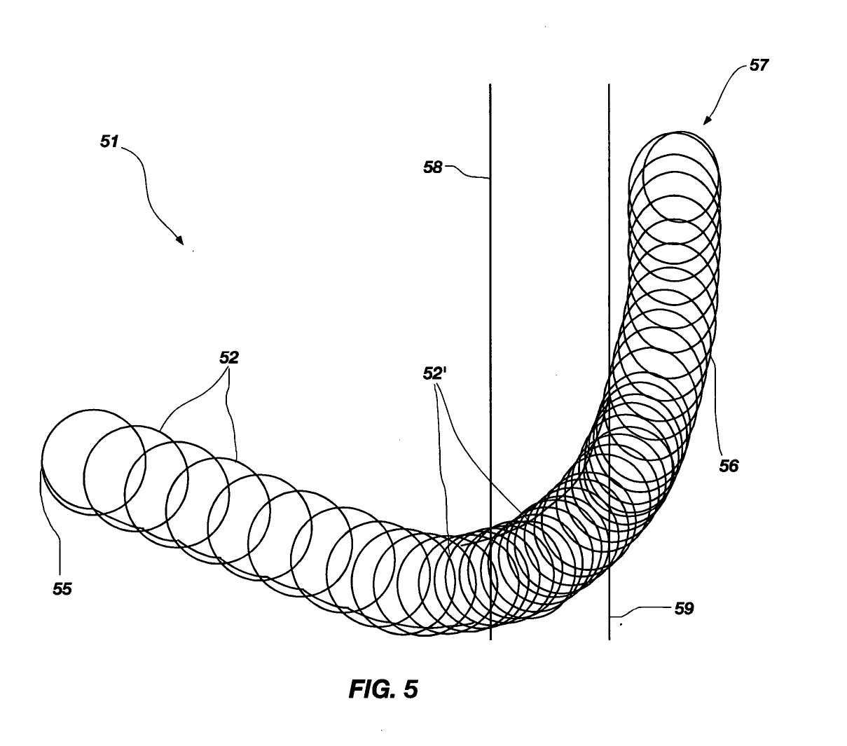

Representative data from a first existing bit 41 (FIG. 4) and a second existing bit 51 (FIG. 5) that drilled an actual formation are plotted. The data indicate that the first existing bit 41 initially drilled at an average ROP of approximately 35 ft/hr (about 11 m/hr) (FIG. 3), decreasing as the bit run continued and the distance drilled increased, until a final average ROP of 15 ft/hr was reached and the bit was pulled out of the hole after reaching a depth of approximately 1,000 ft (about 305 m). The data from drill bit 51 indicates that this bit initially drilled the formation with an average ROP of approximately 40 ft/hr (about 12 m/hr) and that the ROP of the bit decreased to 15 ft/hr (about 5 m/hr) shortly beyond a depth of 1,000 ft (about 305 m).

If a computer model of the bit is used, the computer model of the existing drill bit and the formation that was drilled may be generated by including various parameters, such as characteristics of the formation or formations, drilling equipment, such as mud pump size or rotary drive torque limits, well-bore parameters, such as casing or wellbore dimensions, or other factors. Parameters of the bit may include, without limitation, individually or in combination, bit profile (radius and height), blade dimensions (height, thickness, orientation, number), cutting elements (number, type (PDC, tungsten carbide, natural diamond), back-rake and side-rake angles, radial and axial position, edge geometries, etc.), or hydraulic data (number and size of hydraulic jets which permit drilling fluid to flow out of the bit and into the annulus of the wellbore), or other factors.

FIG. 4 provides an axial view and a profile view of bit 41, a Model HC509Z available from Hughes Christensen Company of The Woodlands, Tex., an operating unit of Baker Hughes Incorporated, assignee of the present invention. The axial view of the bit is a representation of the view one would see if looking directly at the bit from the crown, or leading end of the bit 41 as it drills. A plurality of cutting elements 42 located on a plurality of blades 43 is visible in the axial view of the bit 41, as are a plurality of nozzles 44. In the center of the bit 41 is the cone 45 and at the outermost radius of the bit is the gauge distance 46, or radial distance. Adjacent the axial view of bit 41 is a schematic representation of the cutting element profile 47 of the bit 41, which shows the radial and axial location of each cutting element 42 of the bit 41 as the bit 41 is rotated about its axis of rotation and the cutting elements 42 pass through a plane that corresponds to the page on which FIG. 4 appears. Two vertical lines, 48 and 49, respectively, indicate the cutting elements 42 that experienced the most wear during the drilling of the formation, as determined from observation or empirically through computer simulation. The cutting elements 42 that appear between vertical lines 48 and 49 may, as shown in FIG. 4, be located within a particular range of radial distances from the axis of rotation of the bit 41, or within a particular range of “radial locations” on the bit 41. As illustrated, bit 41 has nine (9) cutting elements 42 in the radial location defined by lines 48 and 49.

FIG. 5 is a view of the cutting element profile of the bit 51, which is the representation of the radial and axial position of each cutting element 52 as the bit 51 is rotated and each cutting element 52 crosses a plane that corresponds to the page on which FIG. 5 appears. Bit 51 also has several backup cutting elements 52′, seven (7) tungsten-carbide inserts (TCI) represented in the profile view. Region 55 corresponds to the cone of the bit and region 56 corresponds to the gauge, or radius of the bit. In addition, two vertical lines, 58 and 59, respectively, indicate the approximate location of the cutting elements 52 that experienced the most wear during the drilling of the formation, as determined from observation or empirically through computer simulation.

A comparison of the profile 47 of bit 41 in FIG. 4 and the profile 57 of bit 51 in FIG. 5 yields several observations regarding the distribution and number of cutting elements 42 and 52. For example, bit 51 has more cutting elements 52 in total than bit 41, forty-seven (47) cutting elements 52 as compared to forty-four (44) cutting elements 42, plus the additional seven TCI cutting elements 52′ that bit 41 is lacking.

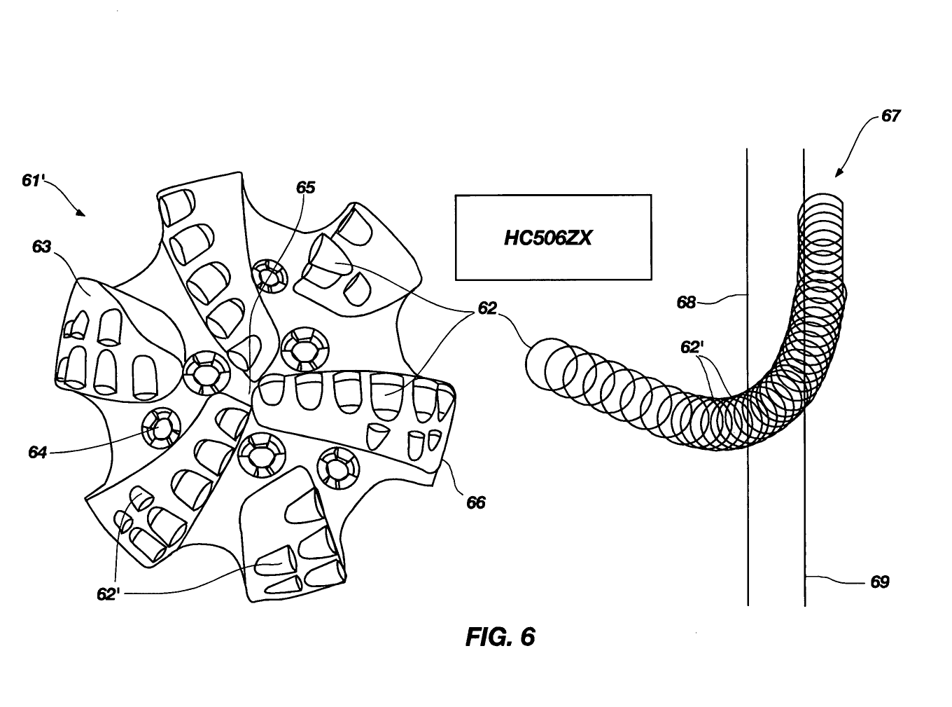

A new bit design, which is referred to in FIG. 3 as bit 61 and identified as Hughes Christensen bit model HC506ZX, is not separately illustrated, but its features are shown in FIG. 6, which illustrates another new bit design.

In FIG. 6, an axial view of bit 61′, which is a modified version of the Hughes Christensen HC506ZX bit with backup cutting elements, is shown. A plurality of cutting elements 62 located on a plurality of blades 63 is visible in the axial view of the bit, as are a plurality of jets 64. Also visible are a series of backup cutting elements 62′. The primary cutting elements 62 are ⅝ inch diameter, whereas the backup cutting elements 62′ are ½ inch diameter. In the center of the bit is the cone 65 and at the outermost radius of the bit is the gauge distance 66, or radial distance. Adjacent to the axial view of bit 61′ is the profile 67. The radial and axial location of each primary cutting element 62 and backup cutting element 62′ is represented as it passes through the plane that corresponds to the page on which FIG. 6 appears. Two vertical lines, 68 and 69, respectively, indicate the location of the cutting elements 62 that experienced the most wear during the drilling of the formation, as determined from observation or empirically through computer simulation. Disposed between the area defined by lines 68 and 69, bit 61′ has six (6) primary cutting elements 62 and six (6) backup cutting elements 62′. Bit 61 (FIG. 3) corresponds to bit 61′ in all respects except that it lacks the backup cutting elements 62′ of bit 61′.

When compared with the bit 51 (FIG. 5) that drilled a formation and whose results were plotted in FIG. 3, bits 61 and 61′ (FIG. 6) have profiles that are flatter than the profile of bit 51, which is somewhat cone-shaped—the cones 65 and the profiles of bits 61 and 61′ between lines 68 and 69 have radii of curvature that are larger than the radii of curvature of the corresponding features of bit 51. The overall result is that the profiles of bits 61 and 61′ have been lengthened; specifically, in this nonlimiting example, the lengths of the profiles of bits 61 and 61′ have been lengthened 0.76 inches (1.9 cm) relative to the profile of bit 51. Other changes include the locations of the cutting elements. Each of bits 61 and 61′ has five (5) cutting elements 62 located in a region proximate the area of the bit 61, 61′ around the cone 65, compared to seven (7) cutting elements in the region of the bit 51 proximate the area of the region 55. While bits 61 and 61′ have fewer cutting elements 62′ in the area of the cone 65 than bit 51, they have an increased number of cutting elements 62 in the areas that correspond to the vertical lines 68 and 69, respectively, in the cutting element profile 67 thereof. For example, in the area between the cone 65 and the radius represented by line 68, bits 61 and 61′ have fifteen (15) cutting elements 62 each, as compared to twelve (12) cutting elements 52 at the corresponding location of bit 51. In the radial area between lines 68 and 69, bits 61 and 61′ both have thirteen (13) cutting elements 62, as compared to the twelve (12) cutting elements 52 in the corresponding area of bit 51. Additionally, in the region between line 69 and gauge distance 66, bits 61 and 61′ both have twenty (20) cutting elements 62, as compared to the sixteen (16) cutting elements 52 in the corresponding location of bit 51. Thus, it can be seen that the cutting elements 62 of bits 61 and 61′ have been moved from the cone 65, where the least work and wear occur, to areas further from the center of the bit 61, 61′. While the total number of cutting elements 62 on bit 61 remains the same as the number of cutting elements 52 of bit 51, additional backup cutting elements 62′ have been added to bit 61′, increasing the overall number of cutting elements 62, 62′ thereon relative to the number of cutting elements 52 of bit 51.

Once the new bits 61 and 61′ were designed and computer models thereof created, a simulation of each new bit 61, 61′ cutting a formation in the model was developed, simulated drilling was effected in a computer model, and the resulting data was collected. Referring again to FIG. 3, the results of simulated drilling with the newly designed bits 61 and 61′ were plotted against the results of drilling with the existing bits 41 and 51. Comparing different possible measurements from FIG. 1, bits 61 and 61′ performed significantly better for the given set of operating parameters as compared to bits 41 and 51. Looking at the criteria of 15 ft/hr, represented by dotted horizontal line 34, which is the average rate of penetration at which the bit may be assumed to be worn and is removed from the hole and replaced, bits 61 and 61′ drilled significantly farther than existing bits 41 and 51. In this instance, the bit 61 drilled approximately 1,359 feet (414 m) and bit 61′ drilled approximately 1,379 feet (420 m) before the ROP dropped to 15 ft/hr (about 5 m/hr), as compared to the approximately 1,060 feet (323 m) of bit 51. This represents an increase of approximately 28% in the total depth drilled. In addition, the rate of penetration averaged over the entire run for bits 61 and 61′ was approximately 3 ft/hr (about 1 m/hr) faster than that for bit 51, or a more than 10% improvement.

Another way to compare the data relates to the average ROP to reach a certain depth, in this case a stop depth of 1,060 feet (323 m) that corresponds to the depth at which the penetration rate of bits 41 and 51 slowed to 15 ft/hr (about 5 m/hr) and is represented by dotted vertical line 33 in FIG. 3. At this point, the ROP of bit 51 averaged over the entire depth drilled (1,060 feet or 323 m) was approximately 29.0 ft/hr (about 9 m/hr), whereas at the same depth both bits 61 and 61′ achieved an average ROP of 39 ft/hr (about 12 m/hr). This represents an improvement of about 33% relative to the depths drilled by the existing bits 41 and 51.

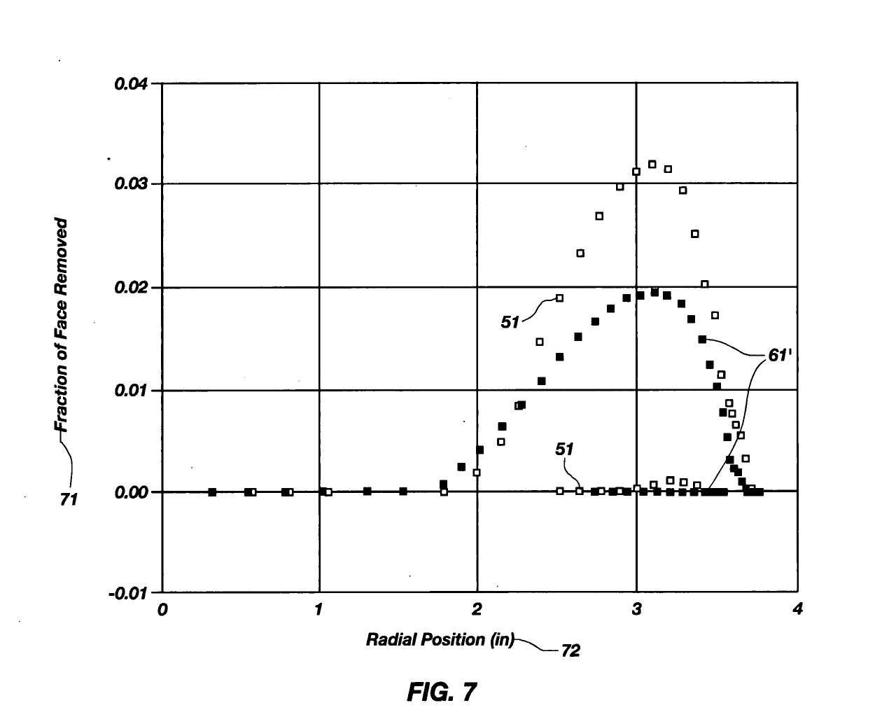

The wear each cutting element undergoes relative to its radial position from the center of the bit may also be compared with the wear of cutting elements at comparable radial positions on one or more other bits. Those cutting elements on the shoulder of the bit, the area between the cone and the gauge of the bit, may wear more quickly than cutting elements at other areas, depending on the geometry of the bit; particularly because elements at the shoulder are the greatest radial distance from the axis of rotation of the bit and, therefore, travel a greater distance, encounter a greater amount of the formation being drilled, and are subject to a greater amount of work than the cutting elements of the bit that are located radially closer to the axis of rotation. FIG. 7 is a graph in which the radial position of each cutting element of bits 51 and 61′ is plotted for a given distance drilled, in this instance 1,060 feet (323 m), which corresponds to the approximate distance drilled for bits 41 and 51. On the Y-axis 71 of FIG. 7, the fraction of the area in square inches of each cutting element removed or worn away is plotted. The X-axis 72 plots the radial position from the center of the bit of each cutting element. FIG. 7 demonstrates that the cutting elements 52 of bit 51 were significantly more worn than the cutting elements 62 at corresponding radial locations on bit 61′. In percentage terms, at locations on the bit where cutting elements are subjected to the greatest amount of work, the cutting elements 62 of bits 61 and 61′ wore about 33% less than the cutting elements of bit 51 located at approximately the same radial positions.

### EXAMPLE 2

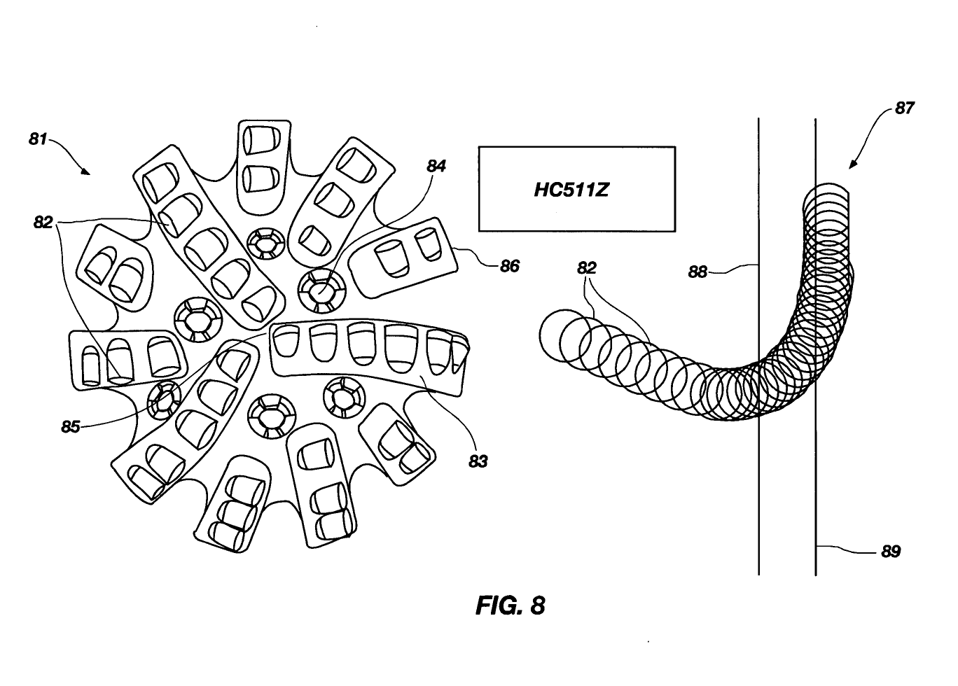

In another example of the method, FIGS. 4 and 8 provide representative examples of both an axial view and a profile view of the cutting elements of two bits for which a computer model was created, and FIG. 5 represents the profile view of a third bit. Both FIGS. 4 and 5 were discussed above. FIG. 8 is graphical representation of Hughes Christensen bit Model HC511Z. Bit 81 has a plurality of cutting elements 82 located on a plurality of blades 83, visible in the axial view of the bit, as are a plurality of jets 84. In the center of the bit is the cone 85 and at the outermost radius of the bit is the gauge distance 86, or radial distance. Adjacent the axial view of bit 81 is the profile 87. The radial and axial location of each primary cutting element 82 is represented as it passes through the plane that corresponds to the page on which FIG. 8 appears. Two vertical lines 88 and 89 indicate the locations of the cutting elements 82 that experienced the most wear during the drilling of the formation, as determined from observation or empirically through computer simulation. Disposed between the area defined by lines 88 and 89, bit 81 has approximately eleven (11) cutting elements 82. This compares to the nine (9) cutting elements in the corresponding area between lines 48 and 49 of bit 41 and the twelve (12) cutting elements 52 in the corresponding area between lines 58 and 59 of bit 51. Each of the bits 41, 51, and 81 had previously drilled a formation, the performance characteristics were recorded, and a computer model of each of the bits 41, 51, and 81 was created.

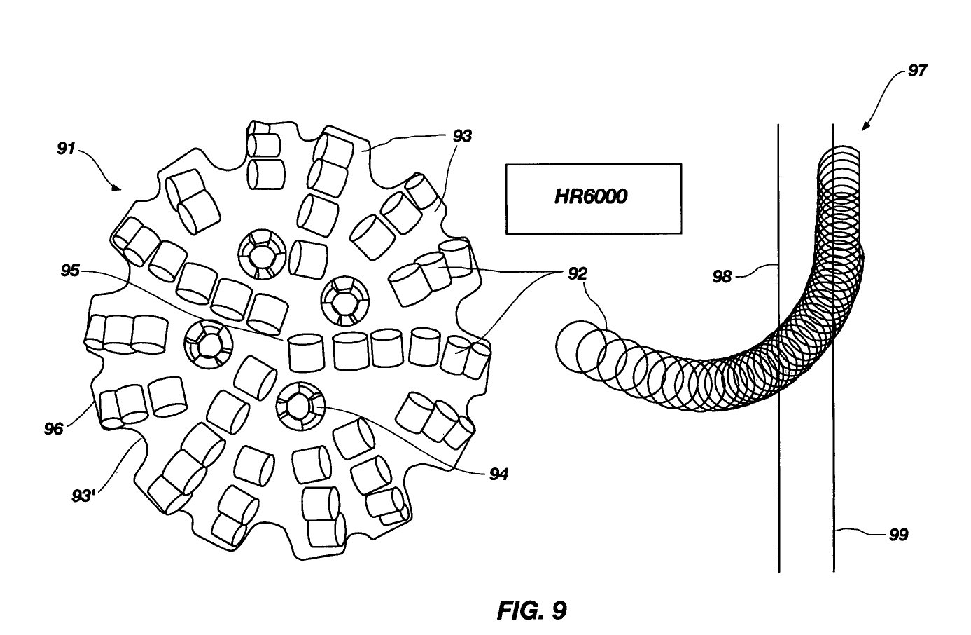

The data obtained from drilling with the bits 41, 51, and 81 was compared with drilling data from another exemplary embodiment of bit 91, which is illustrated in FIG. 9. Bit 91 was designed in response to the results of drilling at least one type of formation with bits 41, 51, and 81. Bit 91 includes a plurality of cutting elements 92. Bit 91 does not have the same conventionally configured blades 43 and 83 shown in FIGS. 4 and 8. Rather, bit 91 has what has been referred to as a “full-face” design in that, when viewed axially, the face of the bit 91 includes regions 93 that are separated by shallow, U-shaped indentations, or cut-outs 93′; thus, the bit 91 does not include conventionally configured blades. Cutouts 93′ permit drilling fluids to flow around the bit 91 and up the annulus of the bore hole. Bit 91 also includes a plurality of nozzles 94, a cone 95 proximate the center of the bit 91 and a gauge 96.

In the cutting element profile 97 of bit 91, several modifications of the bit 91 relative to bits 41, 51, and 81 (FIGS. 4, 5, and 8, respectively), as well as to the radial and axial locations of the cutting elements 92, relative to the radial and axial locations of the cutting elements 42, 52, 82 on bits 41, 51, 81, are readily apparent. For example, bit 91 is flatter in shape, whereas bits 41, 51, and 81 are more cone (or round) shaped. In addition, the height or length of the profile 97 is increased as compared to the profiles 47, 57, and 87 of bits 41, 51, and 81. Also, in the region defined by the vertical lines 98 and 99 located between the cone 95 and the gauge 96, bit 91 has increased the number of cutting elements 92 to a total of thirteen (13) from a minimum of nine (9) cutting elements 42 in the corresponding region of the bit 41 shown in FIG. 4.

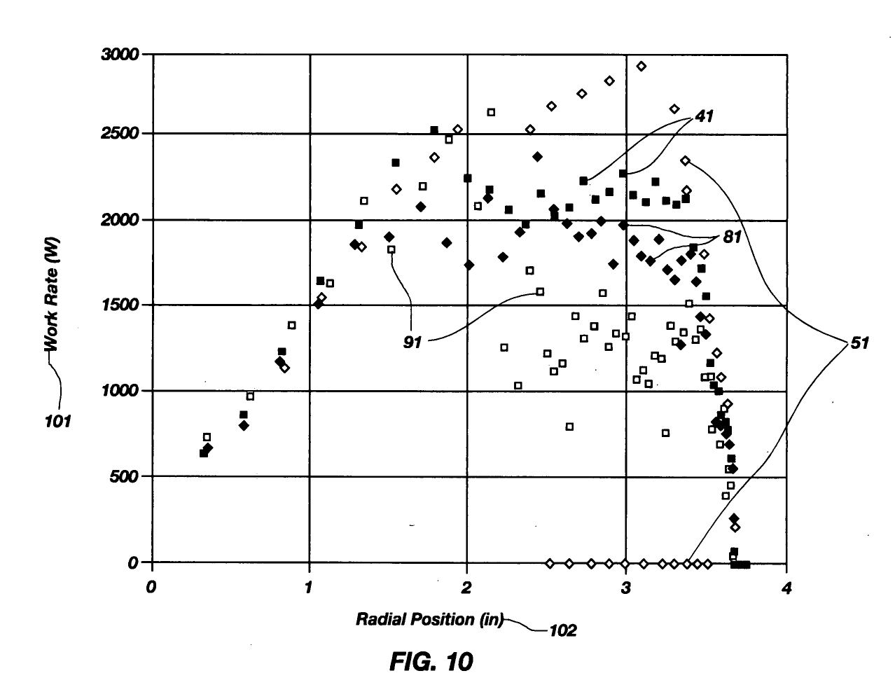

The newly designed bit 91 was subsequently input into the computer model, which was then run for each of the four bits to simulate drilling of a formation. In this instance, an output of the work-force rate that each cutting element underwent during the drilling of the formation was plotted in a graph, as illustrated in FIG. 10. FIG. 10 represents the work-force rate that each bit undergoes when the bit initially begins drilling a formation, i.e., when the bit is new and the cutting elements are not worn. The Y-axis 101 of FIG. 10 represents the work rate that each bit undergoes and the X-axis 102 represents the respective radial position in inches of each individual bit's 41, 51, 81, 91 cutting elements 42, 52, 82, 92, as measured from the center of each bit 41, 51, 81, 91.

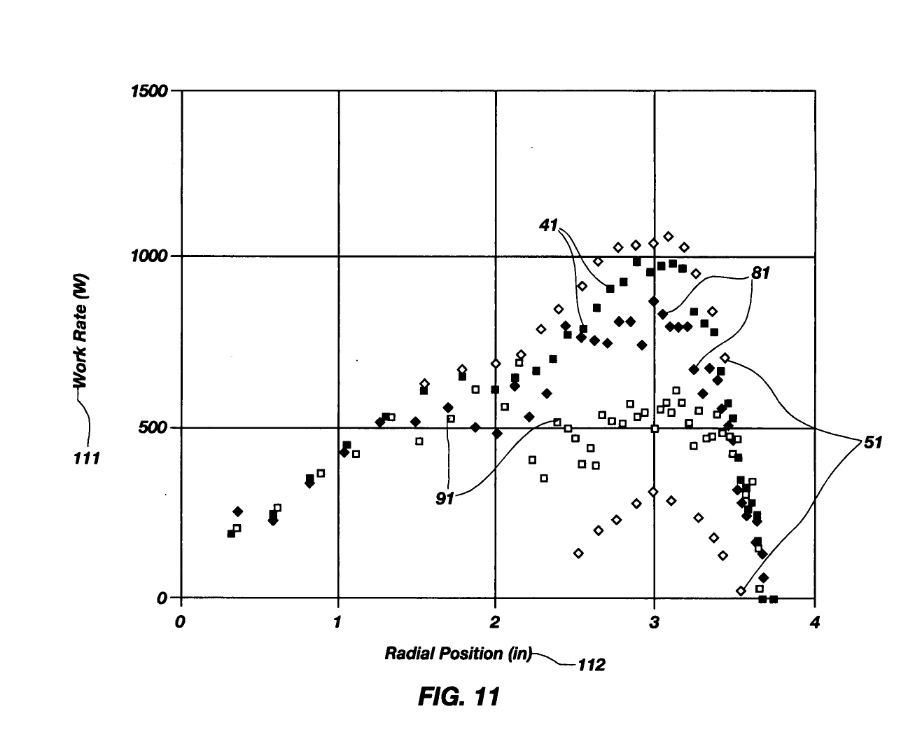

It may be observed that the cutting elements endure the highest work rate in the area between approximately 2½ inches (about 6½ cm) and 3½ inches (about 9 cm) radial distance from the bit center, which corresponds approximately to the radial lines 48, 58, 88, 98 and 49, 59, 89, and 99, respectively. The plot of FIG. 11 generally shows that the farther a cutting element is located from the center of the bit, the higher the work-force rate to which the cutting element is subjected. This may be because the farther a cutting element 42, 52, 82, 92 is positioned radially from the axis of rotation of the bit 41, 51, 81, 91, the farther it travels against a formation as the bit 41, 51, 81, 91 rotates. Although the cutting elements that are positioned the farthest radial distance from the axis of rotation of a bit are typically located along the gauge of the bit, they do not actively cut the formation in the axial direction and, thus, do not necessarily follow the trend of increasing work rate with increased radial distance from the axis of rotation of the bit. It may be observed that the cutting elements endure the highest work rate in the area between approximately 2½ inches (about 6½ cm) and 3½ inches (about 9 cm) radial distance from the bit center, which corresponds approximately to the radial line 48, 58, 88, and 98 and line 49, 59, 89, and 99, respectively.

The cutting elements 92 of the newly designed bit 91 endure a work rate significantly less than the cutting elements 42, 52, 82 of the other bits 41, 51, 81, as the data indicate. In designing bit 91, a number of cutting elements located elsewhere on the other bits have been moved to the region defined between the lines 98 and 99, which endure the greatest work-force rate. The presence of a larger number of cutting elements 92 in this area reduces the work-force rate that any individual cutting element 92 must undergo. A benefit of this is that, for a given formation, the cutting elements 92 will have increased durability, which should permit a drilling operator to run the bit for longer periods of time and drill greater distances before having to remove the bit because it is worn.

The data for bit 51 indicate that several cutting elements located approximately between 2½ inches (about 6½ cm) and 3½ inches (about 9 cm) radial distance from the axis of rotation of the bit 51 appear to be subjected to little or no work. These cutting elements correspond to the TCI (and/or PDC) backup cutting elements 52′. One reason for the lack of work or wear on the TCI (and/or PDC) backup cutting elements 52′ may be that the primary cutting elements 52 endure all of the initial work cutting the formation when the bit 51 is new and the backup cutting elements 52′ do not appear to undergo any work because they might not yet engage the formation.

FIG. 11 is a similar plot to FIG. 10, only the data are taken from the same bits after a representative formation has been drilled. In this instance, rather than data from a new bit, the data plotted are from bits that are worn. Specifically, the data plotted are from bits 41, 51, 81, and 91 after the ROP has fallen to 15 ft/hr, as in the example illustrated in FIG. 3. Again, the Y-axis 111 represents the work rate and the X-axis 112 represents the radial position of each bit's cutting elements. The data indicate that even worn, the cutting elements 92 of bit 91 endure a significantly reduced work-force rate relative to the work-force rate that the cutting elements 42, 52, and 82 endure. Also, the graph indicates that the secondary cutting elements 52′ of bit 51 now bear some of the burden of drilling the formation. This may occur because the primary cutters 52 might have worn sufficiently to permit the secondary cutting elements 52′ to engage the formation. Thus, bit 51 now has more cutting elements engaging the formation, which may explain why the work-force rate on each individual primary cutting element 52 has decreased. When this occurs, the work-force rate of the primary cutting elements 52 approaches the work rate of the cutting elements 42 of bit 41. This further suggests that by increasing the number or volume of cutting elements in the area of the bit that previously endured the most work the work-force rate on individual cutting elements may be reduced, leading to longer bit life.

Because the cutting elements 92 of newly designed bit 91 endure a reduced work-force rate relative to the work-force rates of the cutting elements 42, 52, and 82 on the other bits 41, 51, and 81, other features of the bit 91 might then be optimized. For example, the cutting elements 92 might be oriented more aggressively vis-à-vis the formation. In other words, the back-rake and/or side-rake angles of the cutting elements 92 may be decreased so that they attack the formation more directly. This might improve the ROP that a bit achieves during the run. Other factors may also be modified, either as an alternative or in conjunction with the modified orientation of the cutting elements.

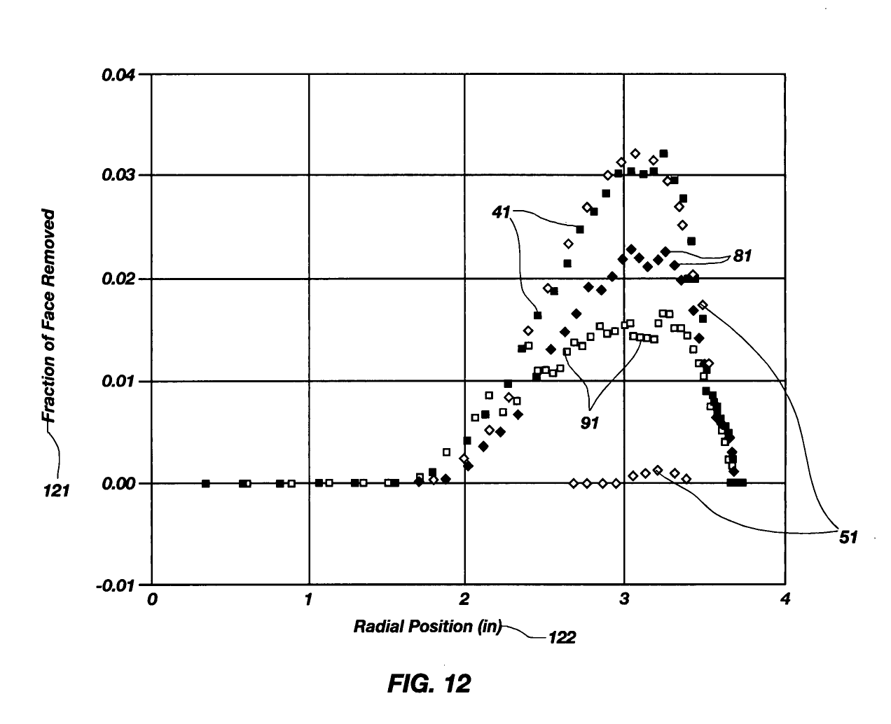

FIG. 12 is a graph in which the data related to the sliding-wear rate of the individual cutting elements 42, 52, 52′, 82, and 92, which was acquired during the simulated drilling of a formation, is plotted. The Y-axis 121 represents the area of each cutting element worn away during the drilling of a formation and is given in square inches. The X-axis 122 represents the radial position of each cutting element in inches. The data plotted comes from the cutting elements 42, 52, 52′, 82, and 92 after the simulated drilling dropped the ROP of each bit to 15 ft/hr (about 5 m/hr). The data indicate that those cutting elements in the region located a radial distance of approximately 3 inches (about 7½ cm) to 3½ inches (about 9 cm) from the axis of rotation of their respective bit have worn more than the cutting elements located at other radial distances from the axis of rotation of each bit. The secondary, backup cutting elements 52′ of bit 51 appear to undergo little wear relative to the primary cutting elements 52, but this may occur because the backup cutting elements 52′ might not engage the formation until the primary cutting elements 52 have worn sufficiently to expose backup cutting elements 52′.

From the data that has been plotted in the graph of FIG. 12, it is apparent that the cutting elements 92 of bit 91 are not subjected to as much sliding-wear as the cutting elements 42, 52, and 82 of bits 41, 51, and 81. Indeed, the sliding-wear of the cutting elements 92 located in the region defined by the lines 98 and 99 in the cutting element profile 97, which correspond to a radial distance of approximately 3 inches (about 7½ cm) to 3½ inches (about 9 cm) from the axis of rotation of the bit 91, wear approximately half as much as the similarly located cutting elements 42 and 52 of bits 41 and 51, respectively, and approximately one-third as much as the similarly located cutting elements 82 of bit 81. This means that the bit 91 with an increased number of cutting elements 92 located in the critical region defined by lines 98 and 99 in FIG. 9 could possibly drill much farther than the bits 41, 51, and 81, all other things being equal.

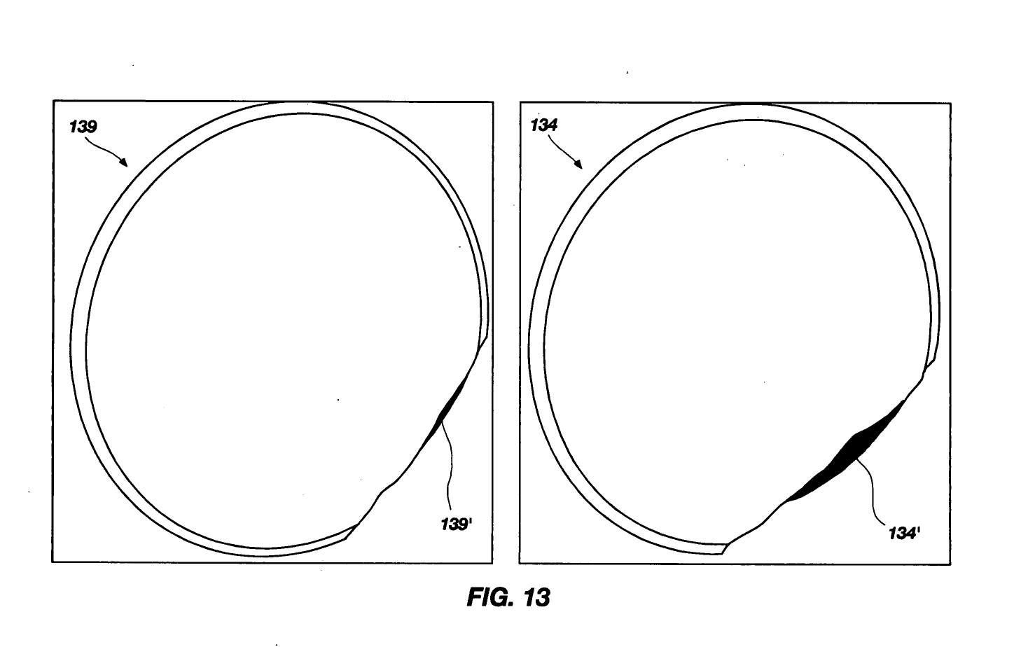

Related to FIG. 12 is the illustration of the actual area removed from an individual cutting element located a given radial distance from the bit, as shown in FIG. 13. Cutting element 134 is a representation of a single cutting element 42 of bit 41, located at a radial distance of approximately 3.26 inches (about 8.28 cm) from the center of bit 41. Shaded area 134′ indicates the area of the cutting element 134 that was worn away during the drilling of the formation, as previously graphed in FIG. 12. In this instance, the simulated drilling of the formation wore away an area of approximately 0.032 square inches (about 0.21 cm²). In contrast, cutting element 139 is a representation of a single cutting element 92 of the newly designed bit 91, located at radial distance of approximately 3.25 inches (about 8.25 cm) from the center of bit 91. Thus, the cutting element 139 is located approximately the same radial distance from the center of bit 91 as cutting element 134 is located from the center of bit 41, and both elements fall within the radial distance in which cutting elements receive about the most wear from 3 inches (about 7½ cm) to 3½ inches (about 9 cm). As can be seen, the drilling of the formation has worn away a shaded area 139′ of the cutting element 139, which is approximately 0.016 square inches (about 0.10 cm²), or one-half the area 134′ worn from cutting element 134 for the same distance drilled. This graphically illustrates that by either moving cutting elements from those areas that undergo low rates of sliding-wear to those areas that receive higher rates of sliding-wear, as was done with bit 91, the sliding-wear rate of individual cutting elements might be improved.

Therefore, as the previous embodiments demonstrate, recording observed characteristics of existing drill bits before, during, and after drilling a formation, may be harnessed to design new drill bits. In each case, the performance (distance drilled, rate of penetration) of existing bits and the work-force rate and the sliding-wear rate that the cutting elements endure during the drilling of a formation has been observed. From this, the cutting elements may be moved from those locations that endure a lower work-force and sliding-wear rate to those areas where the cutting elements suffer higher work-force and sliding-wear rates. After doing this, the new bit may be tested against the performance of the existing bit and the results compared. Further improvements may then be taken. For example, the location, number, or volume of cutting elements may be optimized to achieve better durability and reduce wear. This might include, among other things, holding the volume of cutting elements constant, or reducing or increasing the volume. In addition, the profile of the bit itself may be modified to accommodate the new location of cutting elements. This might entail increasing, decreasing, or altogether removing the blades of an existing design, adjusting the height of the profile, or making other modifications to the bit to improve hydraulics, stability, or other parameters known in the art.

Furthermore, the back-rake and/or side-rake angles or edge geometries of individual cutting elements may be modified in direct response to the changed location and volume of cutting elements. More specifically, the back-rake and/or side-rake angles or edge geometries, for example, may be modified so that one or more cuttings elements of a bit designed for increased durability and efficiency attack the formation in a more aggressive manner, such as by reducing the negative back-rake so that the cutting element is oriented more closely to perpendicular with respect to the formation being drilled. Increasing the aggressiveness of the cutting element might not be possible had the location and volume of the cutting elements not previously been optimized by this method. In this manner, a new bit design might have increased durability (distance drilled) and efficiency (wear characteristics), but also improved aggressiveness (rate of penetration) in a way not previously achievable.

The foregoing embodiments and descriptions merely provide examples of various embodiments. For example, while the embodiments disclosed herein relate to bits with PDC cutters, the method might be performed equally with bits having natural diamond cutters. Therefore, the embodiments disclosed do not limit the scope of the invention or its equivalents, which are governed only by the claims.

1. A method for designing an earth-boring drill bit, comprising:
drilling a formation with a first drill bit that includes a first plurality of cutting elements;
recording at least one characteristic of the first drill bit after drilling the formation;
generating a model of the first drill bit, including:
evaluating at least one of a work-force and a sliding-wear experienced by at least one cutting element of the first plurality from drilling the formation;
designing a second drill bit that includes a second plurality of cutting elements, including:
positioning at least one additional cutting element near a location on a design of the second drill bit where at least one cutting element of the first drill bit was worn.

2. The method of claim 1, wherein drilling the formation comprises drilling a formation in the field or at a rig or drilling a laboratory test fixture.

3. The method of claim 1, wherein drilling the formation comprises computer-simulated drilling.

4. The method of claim 1, wherein positioning at least one additional cutting element includes adding a cutting element to the design of the second drill bit.

5. The method of claim 1, wherein positioning comprises removing the at least one cutting element from a location of the design of the second drill bit that corresponds to a location of the first drill bit where at least one cutting element of the first bit was substantially unworn and replacing the at least one cutting element near the location on the design of the second drill bit where the at least one cutting element of the first drill bit was worn.

6. The method of claim 1, wherein designing further includes:
removing at least one cutting element from a location of the design of the second drill bit that corresponds to a cutting element location of the first drill bit where substantially no wear was experienced.

7. The method of claim 1, wherein designing comprises optimizing the design of the second drill bit to include cutting elements at locations that correspond to cutting element locations on the first drill bit where a greatest amount of wear work-force or sliding-wear was experienced.

8. The method of claim 1, further comprising:
drilling a formation with the second drill bit to verify desired effects from placement of cutting elements thereon.

9. The method of claim 8, further comprising:
repeating the acts of generating, evaluating, and designing if the desired effects do not result from placement of cutting elements on the second drill bit.

10. The method of claim 1, wherein designing includes:
positioning the at least one cutting element for redundancy with another cutting element; and
orienting or configuring at least one of the at least one cutting element and the another cutting element for more aggressive cutting of a formation.

11. The method of claim 1, wherein designing further includes:
adjusting, from a corresponding characteristic of the first drill bit, at least one of:
a blade count;
a blade configuration,
a length;
a profile;
a hydraulic characteristic; and
an operating parameter
of the design of the second drill bit.

12. A method for designing an earth-boring drill bit, comprising:
drilling a formation;
recording a manner in which a first drill bit with a first plurality of cutting elements and a first plurality of blades wears in drilling the formation;
developing a computer-based model that corresponds to the manner in which the existing drill bit wears; and
designing a second drill bit with a second plurality of cutting elements, comprising:
increasing at least one of a volume and a number of the second plurality of cutting elements located in an area of a design of the second drill bit that corresponds to a first region of the first drill bit that experiences greater wear than a second region of the first drill bit; and
modifying at least one of a back-rake angle, a side-rake angle, and an edge geometry of at least one cutting element of the second plurality of cutting elements relative to a back-rake angle and a side-rake angle of at least one of the first plurality of cutting elements.

13. The method of claim 12, wherein drilling the formation comprises drilling a formation in the field or at a rig or drilling a laboratory test fixture.

14. The method of claim 12, wherein drilling the formation comprises computer-simulated drilling.

15. The method of claim 12, wherein increasing comprises removing at least one cutting element from an area of the design of the second drill bit that corresponds to the second area of the first drill bit and replacing the at least one cutting element at the area of the design of the second drill bit that corresponds to the first area of the first drill bit.

16. The method of claim 12, further comprising:
drilling a formation with the second drill bit to verify desired effects from placement of cutting elements thereon.

17. The method of claim 16, further comprising:
repeating the acts of generating, evaluating, and designing if the desired effects do not result from placement of cutting elements on the second drill bit.

18. The method of claim 12, wherein designing includes:
positioning at least one cutting element for redundancy with another cutting element.

19. The method of claim 12, wherein designing further includes:
adjusting, from a corresponding characteristic of the first drill bit, at least one of:
a blade count;
a blade configuration,
a length;
a profile;
a hydraulic characteristic; and
an operating parameter
of the design of the second drill bit.

20. An earth-boring drill bit, comprising:
a body including at least one location where cutting elements experience wear and at least one location where cutting elements experience little or no wear; and
a plurality of cutting elements positioned on the body at the at least one location where cutting elements experience wear so as to optimize at least one of a life of the earth-boring drill bit and a rate of penetration of the earth-boring drill bit.

21. The earth-boring drill bit of claim 20, wherein the plurality of cutting elements is positioned so as to optimize at least one of the life and the rate of penetration of the earth-boring drill bit in a particular formation or type of formation.

22. The earth-boring drill bit of claim 20, wherein no cutting elements are present on the body at the at least one location where cutting elements experience little or no wear.

23. The earth-boring drill bit of claim 20, wherein at least one cutting element at the at least one location where cutting elements experience wear is oriented so as to aggressively attack a formation.

24. The earth-boring drill bit of claim 20, wherein at least one of:
a blade count;
a blade configuration,
a length;
a profile;
a hydraulic characteristic; and
an operating parameter
is tailored to provide a desired drilling characteristic.
